(19) United States
(12) Patent Application Publication
(10) Pub. No.: US 2005/0035226 A1
(43) Pub. Date: Feb. 17, 2005

(54) Spray tool

(75) Inventors: Andreas Schebesta, Dettingen (DE); Karl Heinrich Keim, Neu-Ulm (DE)

Correspondence Address: Charles W. Almer;National Starch and Chemical, 10 Finderne Avenue, Bridgewater, NJ, 08807, US

(73) Assignee: National Starch and Chemical Investment Holding Corporation

(21) Appl. No.: 10/948,400

(22) Filed: Sep. 23, 2004

(30) Foreign Application Priority Data
Apr. 4, 2002 (DE) 02 016 419.0

(51) Int. Cl. B05B 1/14

(52) U.S. Cl. 239/551; 239/69; 239/68; 239/550

(57) ABSTRACT

The invention relates to a spray tool (10) having a source (20, 21) for liquid working medium, a source (22) for control medium and a plurality of spray modules (14). Each spray module (14) has at least one feed (18, 19) for liquid working medium and at least one feed (38) for control medium, and comprises at least one spray element (16) for discharging liquid working medium. The spray modules (14) are combined to form a plurality of spray circuits (K₁, K₂, . . . ), the supply of control medium to which can be controlled independently of the supply of control medium to the other spray circuits. At least one spray circuit (K₁, K₂, . . . ) is assigned a distributor unit (28) which has a plurality of connection points (24) for connecting lines (26) which are guided freely to the feeds (38) of the spray modules (14) belonging to this spray circuit.

The invention relates to a spray tool having a source for liquid working medium, a source for control medium and a plurality of spray modules, each spray module having at least one feed for liquid working medium, which is connected to the source for liquid working medium, and at least one feed for control medium, which is connected to the source for control medium, each spray module furthermore comprising at least one spray element for discharging liquid working medium, and the spray modules being combined to form a plurality of spray circuits each having at least one spray module.

Spray tools of this type, as are known, for example, from DE 44 20 679 A1, are used, for example, in the context with the original shaping and/or deforming of workpieces after a workpiece has been demolded in order to prepare the mold for the next working cycle.

A drawback of the known spray tool is that the feed lines for working medium and control medium have hitherto been guided within the spray tools, which are usually of plate-like structure. It was therefore necessary for the spray modules belonging to each of the spray circuits to be arranged as a structural unit. This restricted the flexibility of the arrangement of the spray modules considerably. It was only possible to overcome this flexibility limit by correspondingly increasing the number of spray circuits. However, this entailed a corresponding increase in the number of control components required, with corresponding costs.

By contrast, it is an object of the invention to provide a spray tool which allows a greater degree of flexibility to be achieved in the arrangement of the spray modules without increasing the number of control components.

According to the invention, this object is achieved by a spray tool, which comprises a source for liquid working medium, a source for control medium, and a plurality of spray modules, each spray module having at least one feed for liquid working medium, which is connected to the source for liquid working medium, and at least one feed for control medium, which is connected to the source for control medium, each spray module furthermore comprising at least one spray element for discharging liquid working medium, the spray modules furthermore being combined to form a plurality of spray circuits each having at least one spray module, for each of the spray circuits, at least the supply of control medium to the spray modules belonging to this spray circuit being controllable independently of the supply of control medium to the spray modules belonging to the other spray circuits, and at least one spray circuit being assigned a distributor unit which has a plurality of connection points for connecting lines which are guided freely to the feeds of the spray modules belonging to this spray circuit.

According to the invention, the spray modules belonging to a spray circuit therefore no longer need to form a structural unit, but rather may be arranged at any desired positions in the spray tool, or in other words: each spray element can be assigned to any desired spray circuit irrespective of its position on the spray tool. As is known per se from the prior art, the spray elements of all spray modules belonging to all the spray circuits can be supplied with liquid working medium via a single feed which is looped through the entire spray head. The spray tool may, for example, comprise two spray heads, specifically one for spraying the fixed part of the mold which is to be treated and one for spraying the movable part of the mold which is to be treated.

It should be noted that the words “guided freely” in the context of the present invention are to be understood as meaning that the connecting lines are not passages which lead through a body, for example a plate, a block or the like, and the walls of which are delimited by the plate, block or the like, but rather these connecting lines are guided through the open air and have their own walls. Flexible hoses or tubes are preferably used as connecting lines which are guided freely. Furthermore, it should be noted at this point that the use of the plural for a specific element after this element has been introduced by wording such as “at least one element” does not restrict the number of such elements to a plurality, i.e. at least two, of these elements, either in the claims or in the description.

In accordance with the above, a spray module is a unit which is combined with regard to the supply of control medium and which comprises at least one spray element. It is not necessarily imperative for the spray elements in this module to be arranged as a structural unit, but this does have design advantages with regard to the supply or distribution of the control medium to the spray elements of a spray module which is under consideration. If each spray element of a spray head is connected on its own, i.e. independently of other spray elements belonging to the spray head, to an associated distributor unit via a connecting line, each of these spray elements forms a dedicated spray module which comprises only a single spray element.

The control medium used may be current (electrical control) and/or compressed gas (pneumatic control) and/or a control liquid (hydraulic control).

As is known per se from the prior art, at least one spray module may also have at least one feed for working gas, for example blowing air, which is connected to a source for working gas, the spray module optionally also having at least one feed for control medium for controlling the discharge of working gas. For reasons of clarity of the arrangement of the multiplicity of connecting lines and for reasons of unambiguous assignment of the connecting lines leading to a spray module for control medium for controlling the discharge of liquid working medium and of control medium for controlling the discharge of working gas, it is preferable if at least some of the connecting lines are coaxial hoses in which both the control medium for controlling the discharge of liquid working medium and the control medium for controlling the discharge of working gas are fed to the respective spray module.

To allow the individual regions of the mold to be treated individually or to allow the mold to be treated with different working media in successive treatment steps, it is proposed for at least two different liquid working media to be fed to at least one spray module. By way of example, one of the working media may be water, which is used to cool the mold, while a further liquid working medium may be a lubricant and/or parting agent in order to prepare the mold for the next working cycle.

It is preferable if at least two different liquid working media, working gas and the control medium for controlling the discharge of liquid working medium and the control medium for controlling the discharge of working gas are fed to all the spray elements.

To control the quantity of working medium discharged, it is possible for this quantity to be metered by the pressure present in the feed for liquid working medium and/or by the duty ratio with which the control medium for controlling the discharge of liquid working medium acts on a control valve for controlling the discharge of liquid working medium.

The invention is explained in more detail below with reference to the appended drawings and on the basis of an exemplary embodiment, in which:

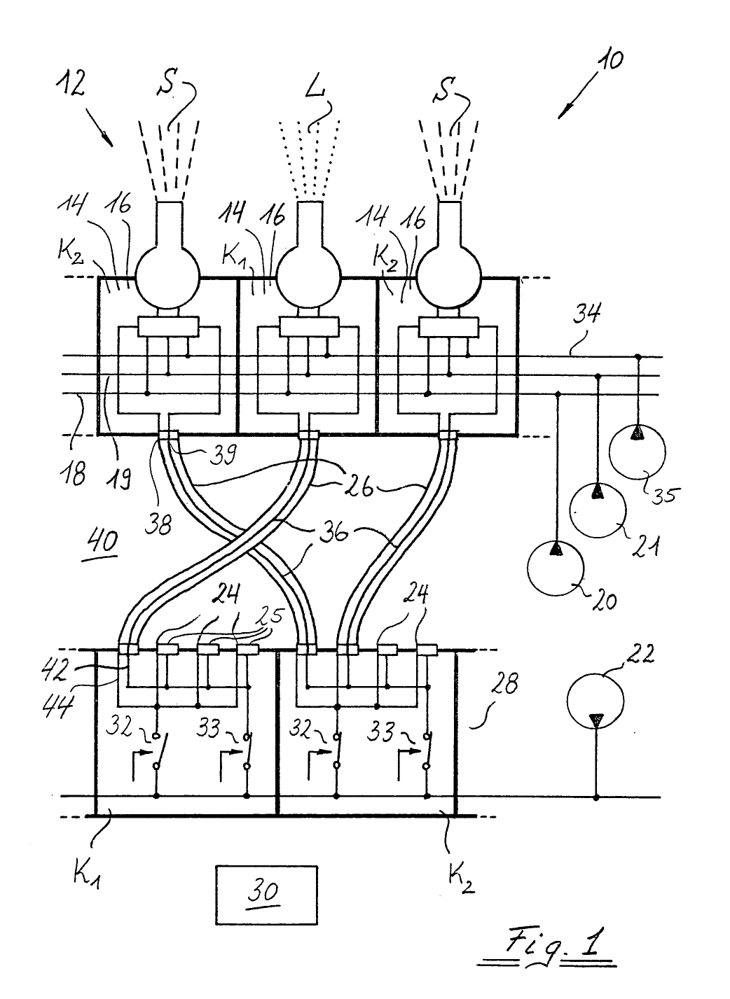

FIG. 1 diagrammatically depicts a spray tool according to the invention;

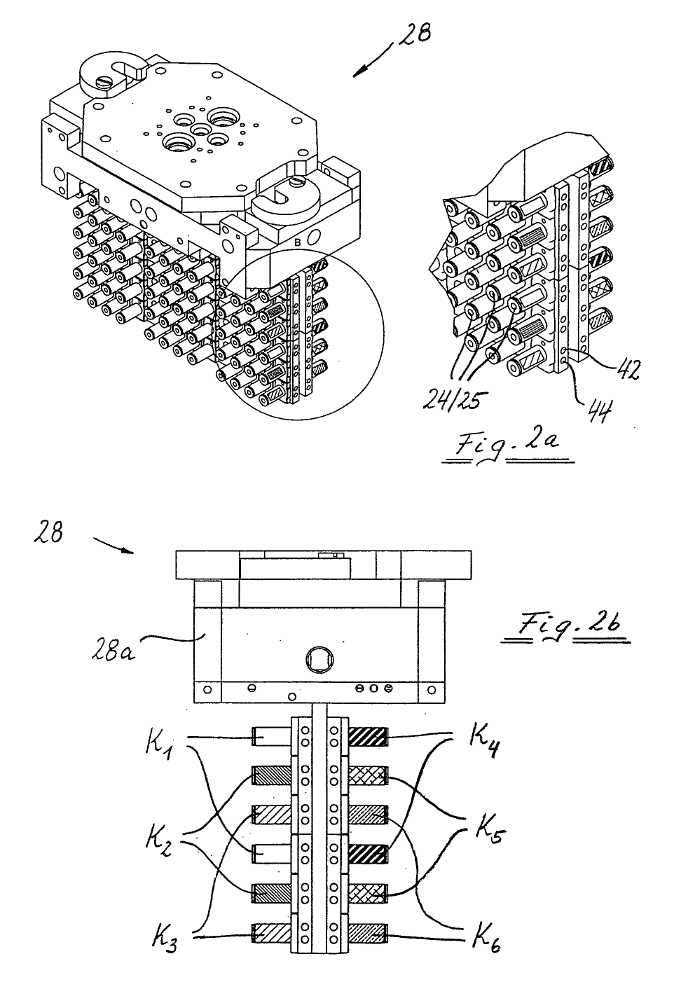

FIGS. 2a & 2b show a perspective view (FIG. 2a) and a side view (FIG. 2b) of a distributor plate;

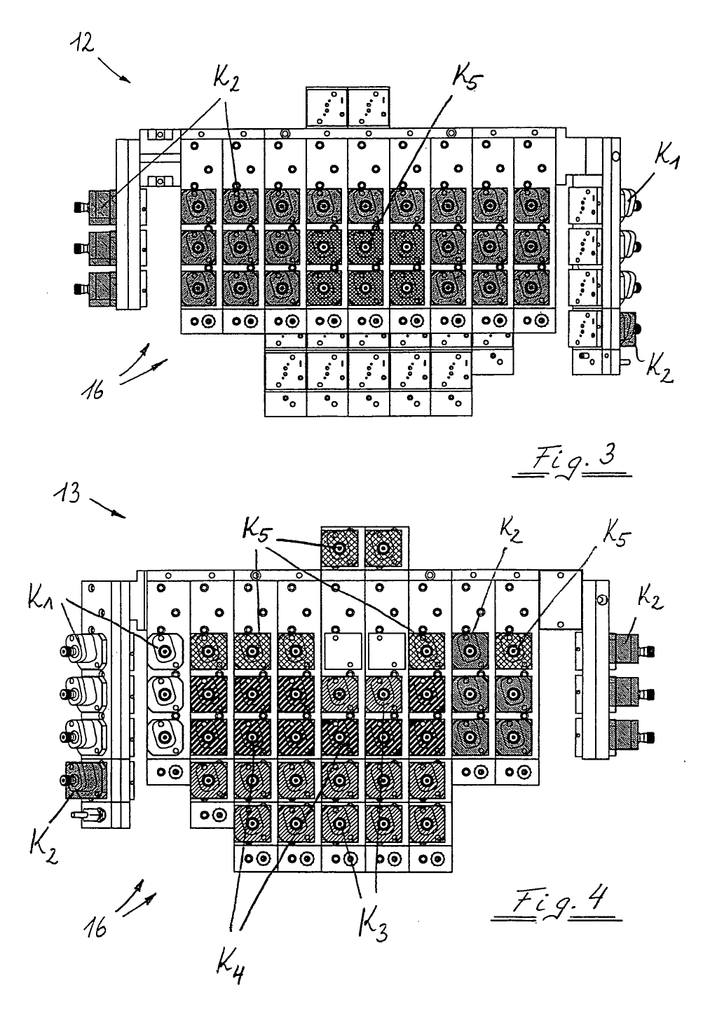

FIG. 3 shows a front view of a spray head for spraying the fixed part of the mold;

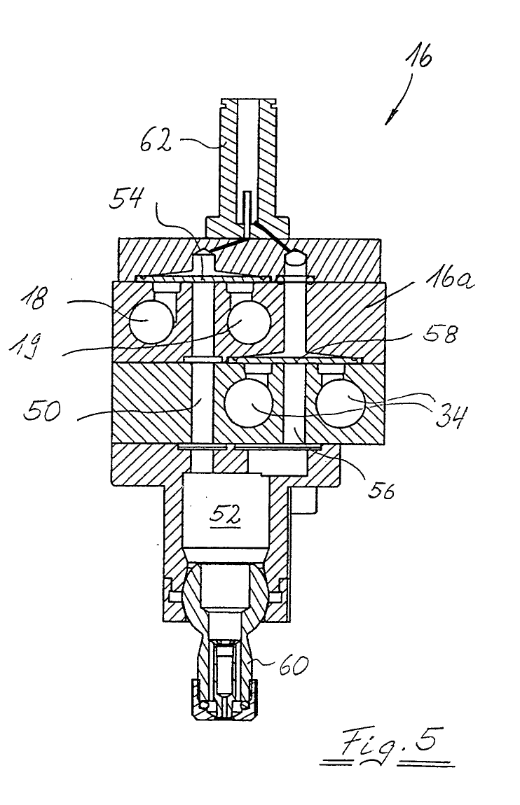

FIG. 4 shows a front view of the spray head for spraying the movable part of the mold; and

FIG. 5 shows a sectional illustration of a spray element.

In FIG. 1, a spray tool according to the invention is generally denoted by 10. More specifically, FIG. 1 illustrates only one spray head 12 of the spray tool 10, for example the spray head for spraying the fixed part of the mold. The spray head 12 comprises a plurality of spray modules 14, each of which comprises only one spray element 16 for reasons of clarity in the illustration. The structure of the spray elements 16 is explained in more detail below with reference to FIG. 5.

A first liquid medium, for example a lubricant and/or parting agent, is fed to each of these spray elements 16 via a common feed line 18 from a source 20, and a second liquid working medium, for example water, is fed to each of these spray elements 16 via a common feed line 19 from a source 21. Furthermore, a control medium, for example compressed air, for controlling the discharge of liquid working medium is fed to the spray elements 16 from a source 22, in the manner which is to be explained in more detail below:

The spray modules 14 or spray elements 16 are combined to form a plurality of spray circuits. By way of example, the middle spray element 16 belongs to a spray circuit K₁, while the left-hand and right-hand spray elements 16 belong to a spray circuit K₂. While the spray elements assigned to the individual spray circuits may be arranged at any desired position on the spray head 12, the connection points 24 for control-medium feed lines 26 leading to the spray elements 16 are structurally combined at a distributor plate 28. This allows all the connection points 24 which are assigned to a specific one of the spray circuits K₁ and K₂ to be connected together to the source 22 for control medium or to be disconnected therefrom by means of switching valves 32, which can be controlled by a control unit 30. In this way, as shown in FIG. 1, the spray elements assigned to the control circuit K₂, on account of the closed switching valve 32, are supplied with control medium via the flexible lines 26 which are guided freely through the space between the distributor plate 28 and the spray head 12 to the connection points 38 of the spray elements 16. Therefore, the left-hand and right-hand spray elements 16 discharge liquid working medium as spray mist S. Which of the working media is discharged depends on which of the sources 20, 21 feeds pressurized working medium to the spray elements 16. Since the switching valve 32 of the spray circuit K, is open, the middle spray element, by contrast, does not discharge any working medium.

To discharge working medium in the form of spray mist S, blowing air is usually also required as atomization medium. Therefore, all the spray elements 16 are connected to a source 35 for blowing air via a common feed line 34. Furthermore, there are flexible feed lines 36 for supplying a control medium for controlling the discharge of blowing air. The connection points between the feed lines 36 and the spray elements 16 are denoted by 39 in FIG. 1, and the connection points between the feed lines 36 and the distributor plate 28 are denoted by 25 in FIG. 1.

Furthermore, it should be noted that the control-medium feed lines 26 and 36 which lead to a specific spray element 16 may be structurally combined to form a twin hose or, as illustrated in FIG. 1, to form a coaxial hose. However, this combined arrangement does not prevent the supply of the two control media from being controlled separately. Therefore, the blowing air supplied via the line 34 can be used not only to atomize working medium but also, for example, to blow-dry the part of the mold which is to be treated. For this purpose, as shown in FIG. 1, in spray circuit K, the switching valve 33 for the control medium for controlling the discharge of blowing air is closed, while the switching valve 32 for the control medium for controlling the discharge of working medium is open. Therefore, the middle spray element 16, which is assigned to the spray circuit K₁, only emits an air stream L.

At this point, it should be noted once again that the particular advantage of the present invention resides in the fact that there is a free space 40 between the distributor plate 28 and the spray head 12, through which space the flexible control-medium feed lines 26 and 36 are guided freely, so that the spray elements 16 which are assigned to the same spray circuit, for example the spray circuit K₂, do not need to be arranged as a structural unit at the spray head 12. This increases the various possible uses of the spray head 12 and therefore of the entire spray tool 10 to a considerable extent.

FIGS. 2a and 2b illustrate a specific exemplary embodiment of a distributor plate 28, the connection points 24/25 of which for flexible coaxial hoses 26/36 are combined to form spray circuits K₁, K₂, K₃, K₄, K_{1 and K}₆. Furthermore, the feed lines 42 for supplying the control medium for controlling the discharge of the liquid working medium and 44 for supplying control medium for controlling the discharge of blowing air are also indicated in each case. The switching valves 32 and 33 may, for example, be combined in the head part 28a of the distributor plate 28. However, it is also possible for them to be formed and arranged separately from distributor plate 28 and head part 28a.

The illustrations of the spray head 12 for spraying the fixed part of the mold shown in FIG. 3 and of the spray head 13 for spraying the movable part of the mold shown in FIG. 4 are intended to illustrate the high degree of flexibility with which the spray elements 16 can be arranged at the spray heads 12 and 13. The way in which the spray elements are assigned to the spray circuits K₁ to K₆ is indicated by the same form of hatching as that used in FIGS. 2a and 2b.

In the text which follows, the structure of a spray element 16 which is known per se is to be explained in more detail with reference to FIG. 5. A feed passage 18 for supplying a first working medium, for example lubricant and/or parting agent, and a second feed passage 19 for supplying a second liquid working medium, for example water, are formed in the housing 16a of the spray element 16. A control diaphragm 54, which can be adjusted between an open state, which allows working medium to pass through, and a closed state, which prevents working medium from passing through by means of the control air supplied via the flexible feed line 26, is arranged in the connecting path 50 which leads from the feed passages 18 and 19 to a mixing chamber 52. Which of the two liquid working media is supplied to the mixing chamber 52 in the open state of the control diaphragm 54 depends on whether the working medium which is supplied in the feed passage 18 or the working medium which is supplied in the feed passage 19 is under pressure.

Furthermore, in the housing 16a there are two feed passages 34 for blowing air, which are in communication with the mixing chamber 52 in a similar manner via a feed line 56 and a control diaphragm 58.

Ultimately, the working medium which has been atomized in the mixing chamber 52 is discharged via a spray nozzle 60, which can pivot freely as a result of its design as a spherical head. Although the spray element 16 illustrated in FIG. 5 operates in accordance with the internal mixing principle, it would be equally possible to use a spray element which operates in accordance with the external mixing principle.

It remains to be added that in FIG. 5 the connection piece for connection of the flexible coaxial hose 26/36 is denoted by 62.

1. A spray tool (10), comprising:
a source (20, 21) for liquid working medium,
a source (22) for control medium,
a plurality of spray modules (14),
each spray module (14) having at least one feed (18, 19) for liquid working medium, which is connected to the source (20, 21) for liquid working medium, and at least one feed (38) for control medium, which is connected to the source (22) for control medium,
each spray module (14) comprising at least one spray element (16) for discharging liquid working medium,
the spray modules (14) being combined to form a plurality of spray circuits (K₁, K₂, . . . ) each having at least one spray module (14) for each of the spray circuits (K₁, K₂, . . . ), at least the supply of control medium to the spray modules (14) belonging to this spray circuit being controllable independently of the supply of control medium to the spray modules (14) belonging to the other spray circuits,
at least one spray circuit (K₁, K₂, . . . ) being assigned a distributor unit (28) which has a plurality of connection points (24) for connecting lines (26) which are guided freely to the feeds of the spray modules (14) belonging to this spray circuit.

2. The spray tool (10) as claimed in claim 1, wherein the control medium is current (electrical control) and/or compressed gas (pneumatic control) and/or a control liquid (hydraulic control).

3. The spray tool (10) as claimed in claim 1 or 2, wherein the connecting lines (26) are, preferably flexible, hoses or tubes.

4. The spray tool (10) as claimed in one of the preceding claims, wherein at least one spray module (14) also has at least one feed (34) for working gas, for example blowing air, which is connected to a source (35) for working gas, the spray module (14) optionally also having at least one feed (39) for control medium for controlling the discharge of working gas.

5. The spray tool (10) as claimed in claim 4, wherein at least some of the connecting lines are coaxial hoses (26/36) in which both the control medium for controlling the discharge of liquid working medium and the control medium for controlling the discharge of working gas are fed to the respective spray module (14).

6. The spray tool (10) as claimed in one of the preceding claims, wherein at least two different liquid working media (18 and 19) are fed to at least one spray module (14).

7. The spray tool (10) as claimed in claim 6, wherein at least two different liquid working media, working gas and the control medium for controlling the discharge of liquid working medium and the control medium for controlling the discharge of working gas are fed to all the spray elements (16).

8. The spray tool (10) as claimed in one of the preceding claims, wherein the quantity of working medium which is discharged is metered by the pressure present in the feed (18, 19) for liquid working medium and/or by the duty ratio with which the control medium for controlling the discharge of liquid working medium acts on a control valve (54) for controlling the discharge of liquid working medium.
